(19) United States
(12) Patent Application Publication
(10) Pub. No.: US 2008/0104183 A1
(43) Pub. Date: May 1, 2008

(54) Graphical Presentation of E-mail

(75) Inventor: Charles A. Eldering, Furlong, PA (US)

Correspondence Address: TECHNOLOGY, PATENTS AND LICENSING, INC., 2003 South EASTON ROAD, SUITE 208, DOYLESTOWN, PA, 18901, US

(73) Assignee: Graphwise, LLC

(21) Appl. No.: 11/924,176

(22) Filed: Oct. 25, 2007

Related U.S. Application Data
(60) Provisional application No. 60/855,036, filed on Oct. 27, 2006.

(51) Int. Cl. G06F 15/16

(52) U.S. Cl. 709/206

(57) ABSTRACT

The invention relates to presenting e-mails to a user in a manner that graphically depicts topic threads between the e-mails and enables the user to pursue a particular thread to view associated e-mails.

### CROSS REFERENCE TO RELATED APPLICATION

This application claims the benefit of U.S. Provisional Patent Application No. 60/855,036, filed Oct. 27, 2006, and entitled Graphical Presentation of E-mail, the entire disclosure of which is incorporated herein by reference.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BRIEF DESCRIPTION OF THE DRAWINGS

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings.

In the Drawings:

FIG. 1 is a use case diagram for the overall system of an embodiment of the invention;

FIG. 2 depicts exemplary data being displayed to a user according to various embodiments of the invention;

FIG. 3 depicts exemplary data pertaining to a group of senders being provided to a user according to a further embodiment of the invention;

FIG. 4 depicts exemplary data pertaining to an individual sender being provided to a user according to a further embodiment of the invention;

FIG. 5 illustrates a flowchart for processing and displaying of e-mails according to an embodiment of the invention; and

FIG. 6 depicts various embodiments of the invention in which hardware and its corresponding functionality is deployed in a network configuration.

### DETAILED DESCRIPTION

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings. The words “right”, “left”, “lower” and “upper” designate directions in the drawings to which reference is made.

Certain terminology is used herein for convenience only and is not to be taken as a limitation on the embodiments of the present invention. In the drawings, the same reference letters are employed for designating the same elements throughout the several figures.

Unified Modeling Language (“UML”) can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the embodiments of the present invention, but do not constrain implementation thereof to any particular hardware or software embodiments. Unless otherwise noted, the notation used with respect to the UML diagrams contained herein is consistent with the UML 2.0 specification or variants thereof and is understood by those skilled in the art.

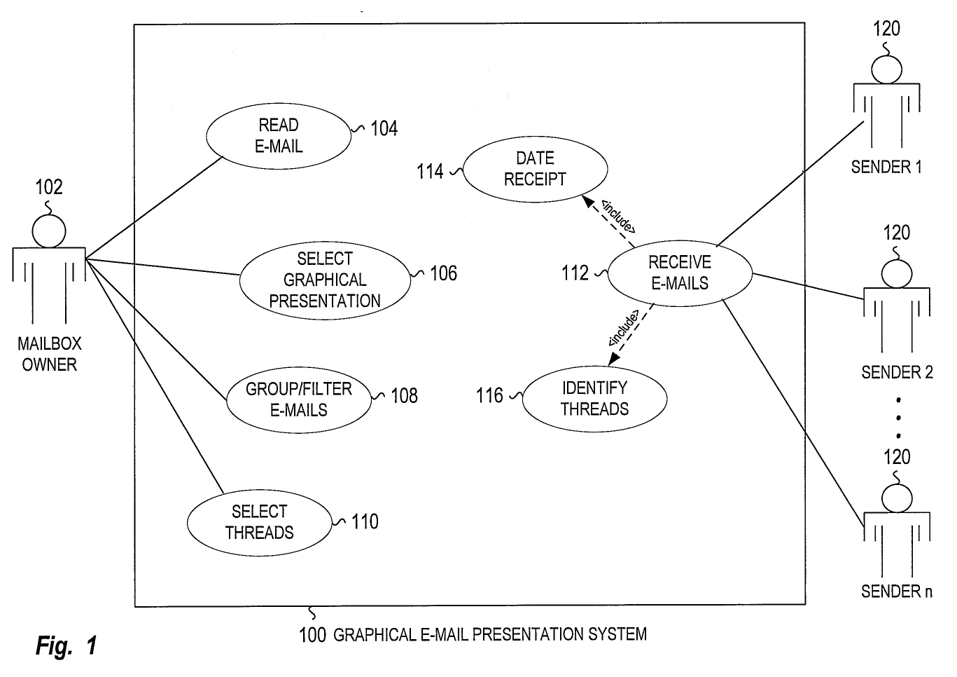

FIG. 1 is a use case diagram for a graphical e-mail presentation system 100 which receives e-mails from a plurality of senders 102, dates the e-mails (along with the originator) and identifies Topic Threads and Connections between e-mails. As used herein, the phrase Topic Thread relates to grouping messages which share a common topic. Connections relate to e-mails which are linked by recipients—replies, individuals who are mutually on the “to” (TO:) line of an e-mail, or individuals that have been copied (cc:) on an e-mail. Also as used herein, the term thread is used to describe a link between e-mails that is either a Topic Thread, a Connection, or both. By utilizing these threads it is possible to present a graphical representation of the relationships between the e-mails. In particular, a general graphical presentation of the e-mails can be developed for the user, and the user can filter the e-mails based on a variety of parameters including TO, DATE, FROM, CC, SUBJECT, FLAG, ATTACHMENT, or other parameter associated with the e-mail. The user can subsequently select a thread presented in one or more the graphical representations of the e-mail and pursue that thread to view the e-mails associated with the thread.

Still referring to FIG. 1, the use case diagram represents the various use cases invoked by the user 102, also referred to as the mailbox owner, as well as the use cases invoked by the general receipt of e-mails from senders 120. As depicted, e-mail received from the senders invokes a receive e-mail use case 112 which can include the dating of the receipt 114 as well as the identification of threads between e-mails 116.

The left hand side of FIG. 1 indicates the use cases invoked by the user/mailbox owner 102, which includes a read e-mail use case 104 which opens e-mail for reading, a select graphical presentation use case 106 which allows the user to select a particular graphical representation, a group/filter e-mails use case 108 which provides for grouping and/or filtering of the e-mails based on any one of a number of parameters including but not limited to the TO, DATE, FROM, CC, SUBJECT, FLAG, ATTACHMENT parameters.

A select threads use case 110 allows the mailbox owner 102 to select a thread as displayed in the graphical representation of the e-mails and allows for e-mails associated with the thread to be displayed to the mailbox owner 102 for further examination and selection.

In one embodiment of the invention, threads are identified through computer based examination of the subject lines, or by identifying e-mails which are replies based on an initial e-mail, or by both. In this embodiment the replies, replies to replies, and subsequent replies constitute a thread. The interrelationships between the TO and CC fields in an e-mail can also be utilized to create threads which are indicative of a virtual e-mail that the mailbox owner has a copy of. For example, if an e-mail is sent from Susan Smith to Tom Jones (with Tom Jones being the mailbox owner), with a CC to Peter Brown, there will be an e-mail from Susan Smith to Peter Brown which is identical to that received by Tom Jones. As such, the e-mail to Peter Brown can be considered to be part of the multi-user thread and can be represented as a virtual e-mail in a graphical representation and the thread associated with the multiple users can be represented such that the participants in the multi-user thread can be readily identified and e-mails which are part of the thread inspected.

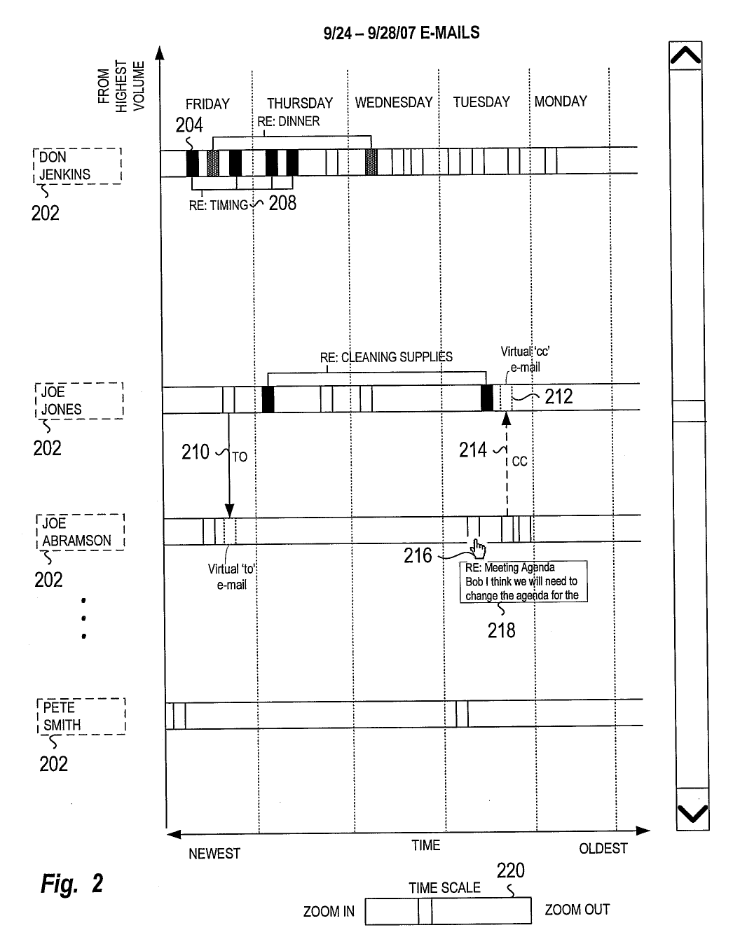

FIG. 2 illustrates features of various embodiments of the invention. For convenience in describing the invention, these features are combined in FIG. 2. It should be noted that various embodiments of the invention exist with one or more of these features in various combinations. In particular, FIG. 2 illustrates one example of a graphical presentation of e-mail in which individual e-mails are illustrated in horizontal rows, with each row being associated with a particular sender 202. That is, e-mails from different senders are organized along different horizontal rows, with each horizontal row containing representations of individual e-mails from that sender 202. In one embodiment, each e-mail received from the sender is illustrated with a graphical mark, such as a rectangle 204. In one embodiment, the horizontal row representing e-mails from the various senders can be organized vertically according to the volume of e-mail received from those senders, with the senders having the highest volumes being located on the top. In one embodiment the organization of e-mails from a sender can be organized chronologically from left to right, with the newest e-mails being towards the left and the oldest e-mails being towards the right. In one embodiment the timescale can be varied by the user, thereby enabling him to zoom in on a region in time based on a sliding timescale 220 which allows for inspection of larger or smaller timeframes.

In FIG. 2, threads can be illustrated using connector bars 206, with the title of the thread 208 (derived from the subject line or as established through other means of inspection of the text of the e-mail) being displayed along with the connector bar. As previously described, if an e-mail was sent by one sender to the user and also copied to another sender, that can be illustrated as a virtual “to” e-mail indicator 210 and serves to show the user that another individual (in this case Joe Abramson) also received the e-mail that was sent to him (in this case by Sue Jones). Similarly, in one embodiment, a virtual “cc” e-mail is illustrated both with a virtual “cc” indicator 214 and as a dotted rectangle 212, and indicates that another individual (in this case Sue Jones) was copied on the e-mail (in this case from Joe Abramson) to the user.

By addressing a particular thread indicator (e.g., item 206) it is possible for the user to retrieve and inspect the e-mails associated with that thread. Still referring to FIG. 2, in one embodiment, the user can move a cursor 216 over the graphical symbol representing an e-mail, and subsequently view the contents of the e-mail which can appear in a box 218 that hovers over the graphical e-mail marker. In one embodiment this is accomplished by accessing the subject line and a portion of the text of the e-mail when the cursor is left over the graphical symbol representing the e-mail for a particular amount of time, and displaying that information such that the user can ascertain the contents of the e-mail.

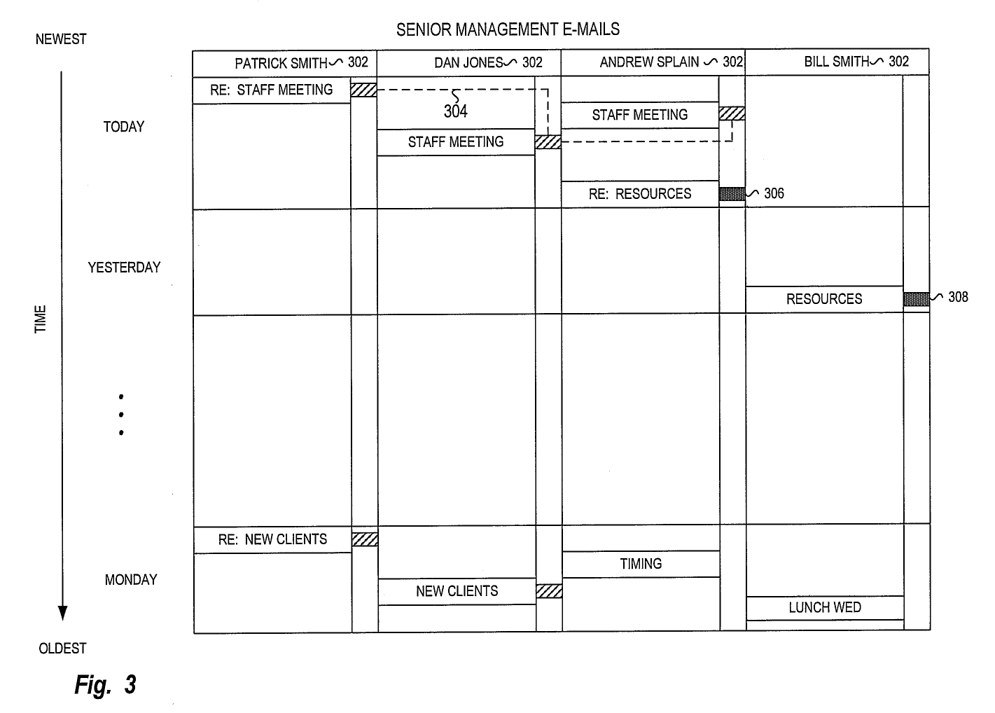

FIG. 3 illustrates an example of a grouping function in which e-mails from a set of individuals can be viewed graphically. For example, if the four individuals shown in FIG. 3 represent the senior management of a company, a user can choose to see all e-mail directed to him from those individuals. As depicted the system presents threads (e.g., “STAFF MEETING,” “RESOURCES,” etc.) and thread indicators 304 between e-mails, as well as using color coding or shading to indicate related e-mails (e.g., items 306 and 308 being identically shaded). The graphical presentation allows the user to rapidly locate e-mails from particular senders and/or to view e-mails that are related and locate the appropriate e-mails on the thread. By clicking on the individual e-mail, the user can rapidly access that e-mail. When accessing the thread the user is able to retrieve the messages that were part of that thread. In the embodiment shown in FIG. 3 e-mails from particular senders are organized in vertical columns. The vertical direction can be used to organize materials chronologically, and in one embodiment the newest materials are placed near the top of the screen, and the older materials towards the bottom.

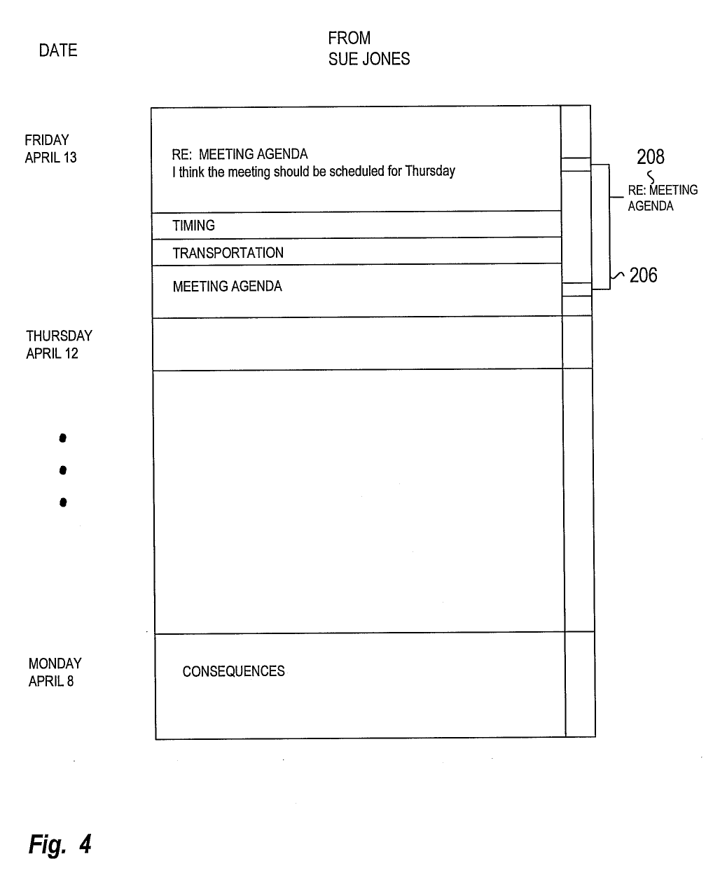

FIG. 4 illustrates an example of linear arrangement of e-mails related to a particular sender. By way of example, one thread is illustrated using connector bar 206 and identified with a “Re: Meeting Agenda” title 208. In this embodiment e-mails from the user are organized such that they can be viewed in chronological order, with the threads between associated e-mails (e.g. from other third party participants) also illustrated to provide the ability to rapidly locate e-mails associated with a particular thread. The e-mails associated with a thread can be inspected individually, or in one embodiment, can be displayed simultaneously. In one embodiment the common part of the text message is suppressed in all but one of the e-mails and only the responses of the other participants in the thread are shown in their e-mails. This allows for rapid visual processing of e-mails associated with a thread.

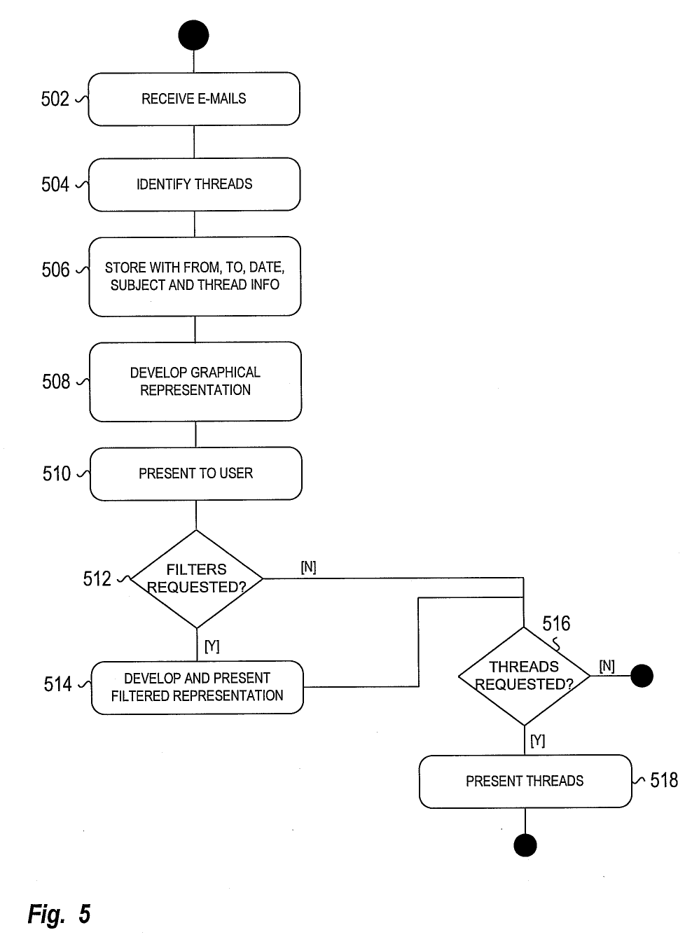

FIG. 5 illustrates a flowchart for processing and display of e-mails according to an embodiment of the invention. E-mails are received in a receive e-mail step 502, and threads are identified at step 504. As noted above, these threads include both Connections between e-mails (e.g., derived from addressee fields) and Topic Threads. In a further embodiment of the invention, Topic Threads are derived through examination of the subject line, body of the e-mail, or subject line in combination with the e-mail body. At step 506 the FROM, TO, DATE, SUBJECT, and thread parameters are stored along with the body of the e-mail itself. Based on this stored information a graphical presentation of the e-mail information can be developed and presented to the user (steps 508 and 510, respectively). Upon presentation of the information, the user at step 512 can select to have the information filtered or to create groups as illustrated in FIG. 3. Once the filtered or grouped information is created it can be presented to the user (step 514). As further illustrated in FIG. 5, with or without such a filtering request, the display of threads can be requested (516). Threads can then be presented with e-mails from those threads being simultaneously displayed (step 518).

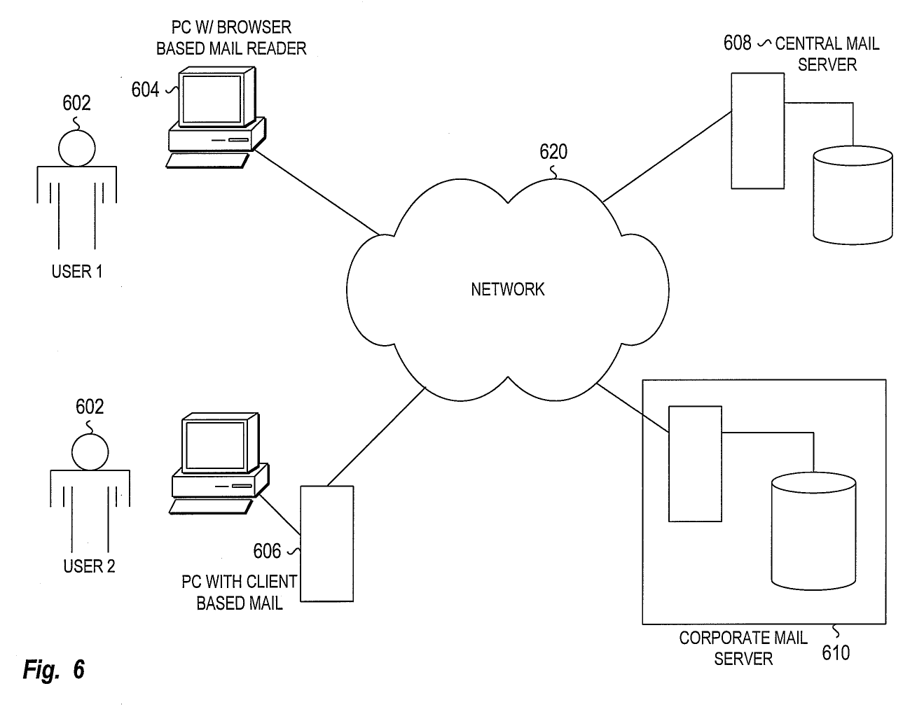

FIG. 6 illustrates a number of embodiments of the present invention, one of which is a central mail server 608 which is accessed by users 602 over a network 620 (e.g., the Internet) using a personal computer 604 with a browser based mail reader. In this embodiment the functionality of the graphical e-mail presentation system is deployed in the central mail server 608 and accessed through the browser. In an alternate embodiment, a centralized mail server (e.g. a corporate mail server 610) is used in conjunction with a computer 606 containing a client side mail application. In this embodiment the client side mail application contains the graphical e-mail presentation system functionality. In other embodiments the functionality is divided between the server side and the client side.

The embodiments of the present invention may be implemented with any combination of hardware and software. If implemented as a computer-implemented apparatus, the present invention is implemented using means for performing all of the steps and functions described above.

The embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Although the description above contains specific examples, these should not be construed as limiting the scope of the invention but as merely providing illustrations of some of the presently preferred embodiments of this invention. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A method for presenting a display of related e-mails, the method comprising:
receiving a plurality of individual e-mails;
identifying Topic Threads relating to at least some of the received individual e-mails; and,
presenting at least a subset of the received plurality of individual e-mails in a manner that visually depicts one or more of the identified Topic Threads.

2. The method of claim 1 wherein the presenting step comprises using visual marks to denote e-mails related by an identified Topic Thread; the marks selected from the group consisting of connector bars, Topic Thread title, color, shading, and combinations thereof.

3. The method of claim 1 wherein the Topic Thread title is derived from an e-mail's subject line.

4. The method of claim 1 wherein the Topic Thread title is derived from inspection of an e-mail's text.

5. The method of claim 1 further comprising:
identifying Connections between e-mails;
presenting at least some of the received plurality of individual e-mails in a manner that visually depicts one or more identified threads wherein the identified threads are selected from the group consisting of identified Connections, identified Topic Threads, and combinations thereof.

6. The method of claim 5 wherein the Connections are selected from the group consisting of replies to an original e-mail, forwards of an original e-mail, e-mails that are transmitted to co-addressees identified in an original e-mail's “TO” line, e-mails that are transmitted to addressees identified in an original e-mail's “CC” line, and combinations thereof.

7. The method of claim 6 wherein the e-mails presented are at least partially determined based on e-mail parameters, the parameters selected from the group consisting of TO, DATE, FROM, CC, SUBJECT, FLAG, ATTACHENT, and combinations thereof.

8. The method of claim 5 wherein the plurality of individual e-mails are each received by a user, and wherein the method further comprises:
permitting the user to select a type of visual display to be employed in the presenting step.

9. The method of claim 8 wherein the type of visual display is selected from the group consisting of a listing of e-mails, arranged by each sender, that are received during a particular time period; a listing of e-mails each of whose senders belongs to a particular defined group of senders; and a listing of e-mails received from a particular sender.

10. The method of claim 8 further comprising:
enabling the user to filter the subset of e-mails presented to yield a presentation of a reduced subset of e-mails.

11. The method of claim 5 wherein the plurality of individual e-mails are each received by a user, and wherein the method further comprises:
enabling the user to select a thread to thereby retrieve and inspect e-mails associated with that thread.

12. The method of claim 5 wherein at least some of individual e-mails are sent by a user, and wherein the method further comprises:
enabling the user to select a thread to thereby retrieve and inspect e-mails associated with that thread.

13. A system for presenting a display of related e-mails, the system comprising:
a server for receiving a plurality of individual e-mails;
a processor for identifying Topic Threads relating to at least some of the received individual e-mails; and,
a display device for presenting at least a subset of the received plurality of individual e-mails in a manner that visually depicts one or more of the identified Topic Threads.

14. The system of claim 13 wherein the Topic Thread title is derived from inspection of an e-mail's text.

15. The system of claim 13 wherein:
the processor is utilized for identifying Connections between e-mails; and
the identified threads are selected from the group consisting of identified Connections, identified Topic Threads, and combinations thereof.

16. The system of claim 15 wherein the plurality of individual e-mails are each received by a user, and wherein the system further comprises:
an input device for permitting the user to select a type of visual display to be employed in the presenting step.

17. The system of claim 16 further comprising:
an input device for enabling the user to filter the subset of e-mails presented to yield a presentation of a reduced subset of e-mails.

18. The system of claim 15 wherein the plurality of individual e-mails are each received by a user, and wherein the system further comprises:
an input device for enabling the user to select a thread to thereby retrieve and inspect e-mails associated with that thread.

19. The system of claim 15 wherein at least some of individual e-mails are sent by a user, and wherein the system further comprises:
an input device for enabling the user to select a thread to thereby retrieve and inspect e-mails associated with that thread.

20. A data storage medium comprising indicia of instructions for a processor to perform a method of presenting a display of related e-mails comprising:
receiving a plurality of individual e-mails;
identifying Topic Threads relating to at least some of the received individual e-mails; and,
presenting at least a subset of the received plurality of individual e-mails in a manner that visually depicts one or more of the identified Topic Threads.

21. The data storage medium of claim 20 wherein the method further comprises:
identifying Connections between e-mails;
presenting at least some of the received plurality of individual e-mails in a manner that visually depicts one or more identified threads wherein the identified threads are selected from the group consisting of identified Connections, identified Topic Threads, and combinations thereof.

22. The data storage medium of claim 21 wherein the plurality of individual e-mails are each received by a user, and wherein the method further comprises:
permitting the user to select a type of visual display to be employed in the presenting step.

23. The data storage medium of claim 22 wherein the method further comprises:
enabling the user to filter the subset of e-mails presented to yield a presentation of a reduced subset of e-mails.

24. The data storage medium of claim 21 wherein the plurality of individual e-mails are each received by a user, and wherein the method further comprises:
enabling the user to select a thread to thereby retrieve and inspect e-mails associated with that thread.

25. The data storage medium of claim 21 wherein at least some of individual e-mails are sent by a user, and wherein the method further comprises:
enabling the user to select a thread to thereby retrieve and inspect e-mails associated with that thread.
